(19) United States
(12) Patent Application Publication
(10) Pub. No.: US 2009/0201127 A1
(43) Pub. Date: Aug. 13, 2009

(54) Bicycle securing system

(76) Inventors: Anatoli Stobbe, Barsinghausen (DE); Wilfried Herrmann, Hannover (DE)

Correspondence Address: COLLARD & ROE, P.C., 1077 NORTHERN BOULEVARD, ROSLYN, NY, 11576, US

(21) Appl. No.: 12/378,149

(22) Filed: Feb. 11, 2009

(30) Foreign Application Priority Data
Feb. 13, 2008 (DE) 10 2008 009 012.3

(51) Int. Cl. G05B 19/00

(52) U.S. Cl. 340/5.6; 70/233

(57) ABSTRACT

A bicycle securing system consisting of a bicycle station as well as at least one bicycle is described.

A bicycle securing system consists of a user communication terminal and at least one bicycle stand. The bicycle stand and the bicycle comprise retaining and docking means as well as registration and identification means. The retaining and docking means comprise a pin provided with a bolt lock on the bicycle side and a pin and bolt receptacle on the bicycle stand side. The registration and identification means comprise a reading and control device on the bicycle side and a passive RFID data carrier on the bicycle stand side.

The invention relates to a bicycle securing system according to the preamble of claim 1.

Bicycle securing systems are used, for example, in tourist centres to make bicycles available on payment of money to tourists for individual excursions. For a profitable operation the usage should be as reliable and simple as possible for the user but misuse and vandalism should be difficult.

It is the object of the invention to ensure secure storage of the bicycles, easy access to stored bicycles for a user and reliable logging and possibly accounting of the usage in a bicycle securing system.

This object is achieved in a bicycle securing system according to the preamble of claim 1 by the features of this claim.

Further developments and advantageous embodiments are obtained from the dependent claims.

The bicycle is fixed positively by the retaining and docking means and at the same time the registration and identification means detects in which bicycle stand the bicycle is stored. For this, the retaining and docking means ensures that the passive RFID data carrier located in the bicycle stand is optimally coupled with the active reading and control device of the bicycle and thus characteristic data of the bicycle stand can be transmitted to the reading and control device of the bicycle.

According to one embodiment, the retaining and docking means can be configured in such a manner that the bicycle is held upright by means of a pin in the pin receptacle of the bicycle stand of a bicycle station and is fixed against unauthorised removal by means of a bolt lock in a bolt receptacle of the bicycle stand.

The arrangement of the active parts of the registration and identification means in the bicycle and of the passive RFID data carrier in the bicycle stand makes it possible to set up bicycle stands of a bicycle station without power supply and data connection amongst one another or with a user communication terminal so that expensive construction work can be dispensed with and the erection sites of the bicycle stands can easily be changed without renewed groundworks becoming necessary. The bicycle securing system according to the invention can thus be installed and changed particularly cost-effectively and flexibly in city areas.

In a further development, the bolt lock and the reading and control device are disposed in a common stem housing.

This has the advantage that the bolt lock and the reading and control device can cooperate without external cable connections on the bicycle. Furthermore, attachment is possible independently of the type of bicycle and therefore equipping or retrofitting of inexpensive standard bicycles is possible.

The pin can be an integral component of the stem housing.

By this means, a compact structural unit is achieved which at the same time fulfils the functions of holding in the bicycle stand and by fixing in the bicycle stand, offers protection against unauthorised removal and furthermore ensures optimal coupling between the reader and RFID data carrier.

The stem housing can be fastened to the steering shaft of the front fork of the bicycle.

This reduces the possibility of forcible damage to, or destruction of the retaining and docking means, compared to a fastening on the frame of the bicycle. Whereas only the lever arm of the handlebars would be available for forceful impact when the stem housing is fastened to the steering shaft of the front fork, if this were fastened to the frame of the bicycle, the substantially greater lever arm from the rear wheel would be available.

Furthermore, the stem housing can be supported by means of a fork support on the front fork of the bicycle.

By this means, firstly the load of the stem housing and of any bicycle basket which is optionally present is better intercepted, secondly however, a defined position is achieved for all bicycles of the same type so that in turn the lock receptacle of the bicycle stand can have a narrow tolerance in height above the ground.

The bicycle stand can have lateral flanks which cover the front forks of the bicycle in the docked state.

As a result, screw connections of the front wheel axle to the front fork are inaccessible so that the front wheel cannot be detached from the front fork or detached only with difficulty.

According to a further development, the bolt lock consists of a double bolt which is disposed spreadably in opposite directions in the pin and an actuating device, wherein the actuating device comprises a hand lever, a coupling which can be actuated by the reading and control device as well as a drive rod and direction-changing transmission means.

Due to the bolt lock comprising the double bolt which is disposed spreadably in opposite directions in the pin, the bicycle is locked positively in the pin receptacle of the bicycle stand. The actuating device makes it possible to move the locking pins of the double bolt simultaneously in opposite directions with a single hand lever. The coupling which can be actuated by the reading and control device ensures that the hand lever only allows the closing and opening of the bolt lock in cases of authorisation otherwise it turns with no result. Whereas a locking of the hand lever against manual actuation could be forcibly overcome with the aid of a tool, e.g. pliers, this possibility for sabotage does not exist in the present embodiment.

A cable lock of a securing cable can further be disposed in the stem housing. In this case, an actuating member of the cable lock can be coupled to the drive rod of the actuating device of the bolt lock.

Such a cable lock is expedient to connect a loan bicycle to a suitable stationary means en route. By coupling the cable lock to the drive rod of the actuating device of the bolt lock, the same actuating device is used for two cases of application, namely docking in the bicycle stand of the bicycle station and securing to any arbitrary securing means.

The reading and control device preferably comprises a reader for the RFID data carrier of the bicycle stand, a reader for a user data carrier, an evaluation and control device and a rechargeable battery.

Due to the two independent readers, on the one hand the RFID data carrier can be read in the bicycle stand and on the other hand, a user data carrier with which a user can be identified as an authorised user of the bicycle after application and registration at the user communication terminal and the actuation device for actuating the bolt lock and the cable lock can be activated.

In a first alternative, the reader for the user data carrier is disposed in the stem housing. This ensures optimal protection of the reader and a short connection to the controller.

In a second alternative, the reader for the user data carrier or a reading antenna of this reader is disposed in an offset manner in a handlebar covering of the bicycle.

In this solution, cabling or a radio link to the controller is indeed required but in return, the access and operation, especially for a new user not yet familiar with the bicycle securing system is made substantially easier.

According to a further development, the reading and control device comprises a communication device for data exchange with the user communication terminal.

This makes non-contact data exchange possible between the reading and control device assigned to the respective bicycle and the user communication terminal. Registration and identification data can thus be exchanged, processed centrally in the user communication terminal, stored and exchanged with a central unit.

According to a further development, the reading and control device is connected to a hub dynamo in the front wheel of the bicycle and the charging of the rechargeable battery is controlled by the evaluation and control device.

In this solution, in contrast to an external dynamo, a continuous galvanic connection to the dynamo and therefore recharging of the rechargeable battery over a short distance via electrical lines which can be laid so that they are protected is possible without any possibility of influence by the user. The securing of the power supply and recharging of the rechargeable battery is thereby ensured.

Furthermore, a cable store for the securing cable can be disposed on the stem housing.

In addition, the cable store for the securing cable can be disposed between the stem housing and a bicycle basket fastened thereabove.

By this means, on the one hand the securing cable is located and stored directly on the stem housing so a short connection to the cable lock is ensured and on the other hand, the securing cable can be stored in a space-saving manner and without risk for the cycling operation. In contrast to other solutions in which a securing cable is stored in a bicycle basket above the front wheel, the storage of the securing cable in the cable store does not adversely affect the possibility of using the bicycle basket for luggage.

The cable store can be configured as a cable drum.

It is thereby possible to wind up the cable in a user-friendly and space-saving manner when not in use.

Furthermore, a front light of the lighting device can be disposed in an inner recess of the pin. The front light is thereby protected on the one hand during cycling and on the other hand, when the bicycle is docked in the bicycle stand, it is inaccessible and therefore protected against vandalism.

The reading and control device can be connected to a lighting device of the bicycle and the lighting device can be controlled by the evaluation and control device via a photosensor.

This design allows the lighting device to be switched on and off reliably without any user intervention and at the same time uses the control device provided. Furthermore, the rechargeable battery can also be used for lighting in the stand.

The invention is explained hereinafter with reference to an exemplary embodiment which is shown in the drawings. In the figures:

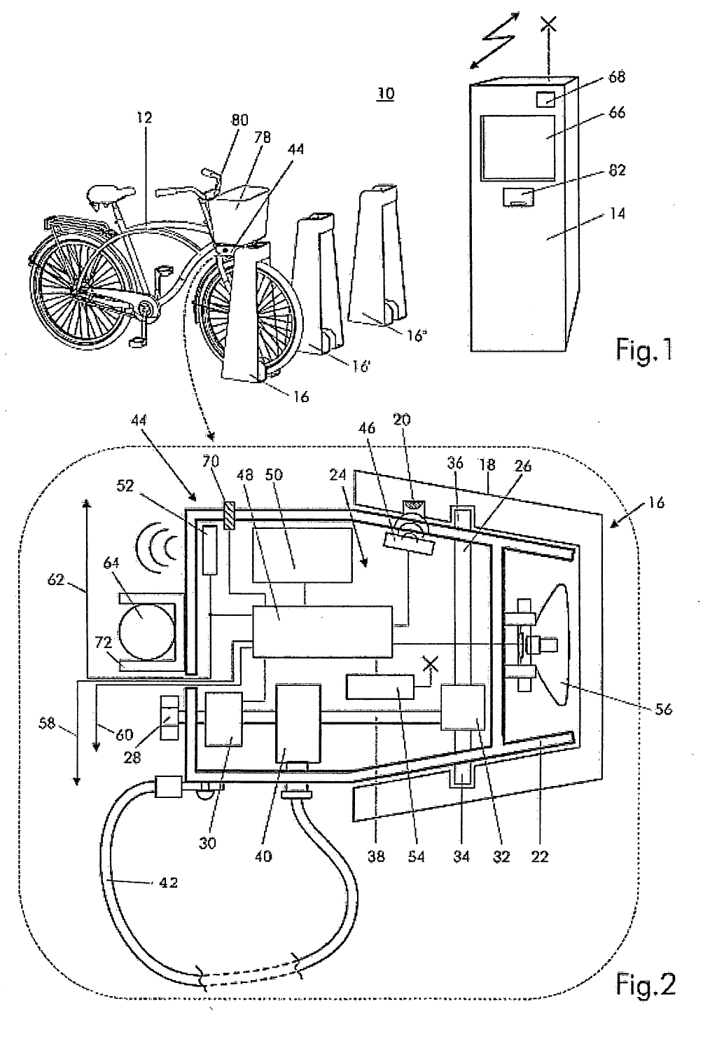

FIG. 1 shows a bicycle securing system consisting of a bicycle station with a user communication terminal and two bicycle stands as well as a bicycle in the docked position,

FIG. 2 shows a schematic section through a stem housing with components of the retaining and docking means as well as registration and identification means on the bicycle side,

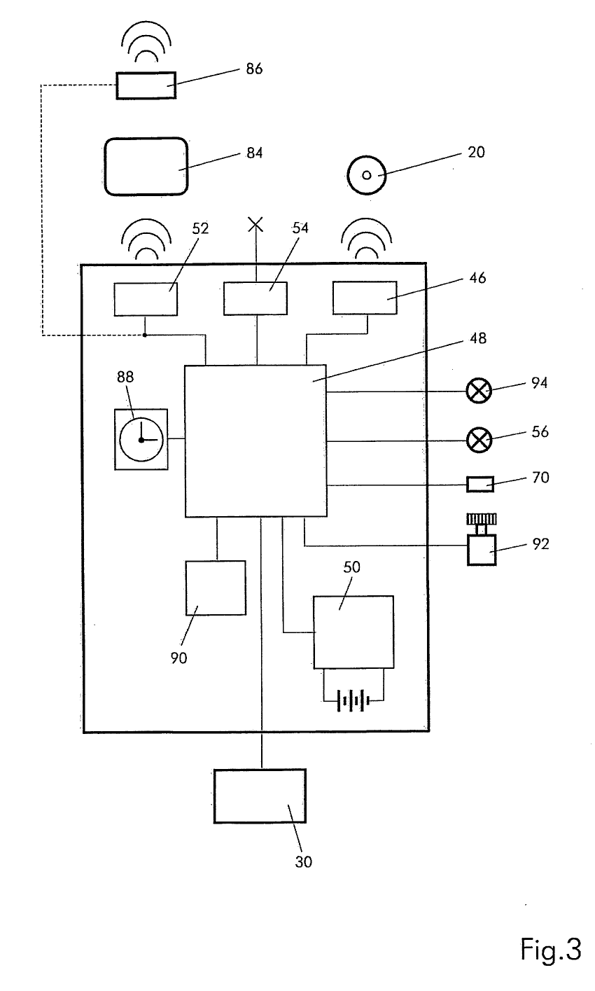

FIG. 3 shows a block diagram of the electronic components of the bicycle and

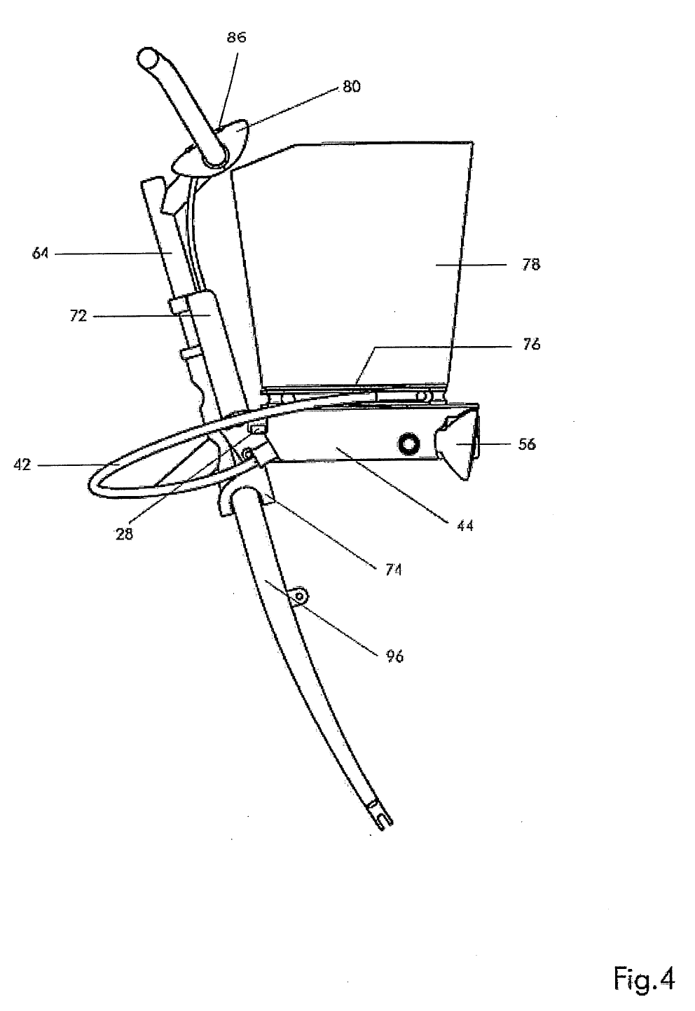

FIG. 4 shows a side view of the front part of a bicycle with the stem housing and fastening means.

FIG. 1 shows a bicycle securing system consisting of a bicycle station 10 with a user communication terminal 14 and three bicycle stands 16, 16′ and 16″ as well as a bicycle 12. Retaining and docking means as well as registration and identification means are disposed on the bicycle stand 16 and on the bicycle 12 and specifically as retaining and docking means, a pin with a bolt lock on the bicycle 12 and a pin and bolt receptacle on the bicycle stand 16, and as registration and identification means, a reading and control device on the bicycle and a passive RFID data carrier on the bicycle stand.

In the diagram according to FIG. 1 the bicycle 12 is located in the bicycle stand 16. The bicycle 12 is held perpendicularly in this position by means of a pin and is fixed from being removed from the bicycle stand 16 by a bolt lock. At the same time, in this position an RFID data carrier of the bicycle stand enters into the range of a reading antenna or a reader of the reading and control device of the bicycle so that characteristic data of the RFID data carrier of the bicycle stand 16 can be read.

FIG. 2 shows in detail a section through a stem housing 44 fastened to the bicycle 12 with the lock bolt and the pin 22 as well as the reading and control device in the pin receptacle 18 of the bicycle stand 16 with its RFID data carrier 20.

The stem housing 44 is fastened via fastening means 72 to a steering shaft 64 of the front fork of the bicycle 12 and is additionally supported by means a fork support 74 on the bicycle fork (FIG. 4). Due to this configuration, it is possible to retrofit conventional bicycles without needing to make constructive changes to the frame or the fork. In order that different inclinations of the steering shaft 64 can be compensated, an adjusting device can be disposed between the fastening means 72 and the stem housing 44. The fastening means 72 for fastening to the steering shaft 64 comprises screws whose screw heads are countersunk and have a profile which requires a special tool for handling the screws.

As can be seen from the diagram in FIG. 2, the pin 22 is an integral component of the stem housing 44 and tapers towards the front so that insertion into the pin receptacle 18 of the bicycle stand 16 is made easier and at the same time a defined stop is achieved when this is pushed in completely. The bolt lock consists of a double bolt 26 which is disposed spreadably in opposite directions in the pin 22, comprising locking pins 34 and 36 and an actuating device. The actuating device comprises a hand lever 28, a coupling 30 which can be actuated by the reading and control device, a drive rod 38 and a direction-changing transmission means 32. In addition, a cable lock 40 of a securing cable 42 is disposed in the stem housing 44. An actuating member of the cable lock 40 is coupled to the drive rod 38 of the actuating device of the lock bolt and therefore can be actuated jointly with the lock bolt itself.

The reading and control device comprises a reader 46 for RFID data carriers 20 of the bicycle stands 16, 16′, 16″, a reader 52 for a user data carrier, an evaluation and control device 48, a chargeable rechargeable battery 50 and a communication device 54 for data exchange via a further communication device 68 of the user communication terminal 14.

Instead of the reader 52, an offset reader or an antenna of the reader 52 can be connected to the evaluation and control device 48 via a connection line 62, the reading antenna or the reader being disposed in a handlebar covering 80 of the bicycle 12 shown in FIG. 1.

Another cable 58 leads to a hub dynamo which during cycling provides energy for supplying the electrical components and for buffering or charging the rechargeable battery 50. The reading and control device 48 is further connecting to a lighting device of the bicycle and specifically to a front light 56 which is accommodated in a protected manner in a cavity of the pin 22 and via a cable 60 to a rear light. The lighting device is automatically switched on and off by the evaluation and control device 48 via a photosensor 70 without requiring any user intervention

Additionally to FIG. 2, FIG. 3 shows a block diagram of the electronic components of the bicycle 12. The reading and control device comprises a reader 46 for RFID data carriers 20 of the bicycle stands, a reader 52 for a user data carrier 84, an evaluation and control device 48, a memory 90 connected to the evaluation and control device 48, a timer 88 for measurement of real and delay times, a chargeable rechargeable battery 50, a communication device 54 for data exchange by means of a further communication device 68 of the user communication terminal 14 (FIG. 1).

In addition to the reader 52 integrated in the stem housing 44, an offset reader 86 or an antenna of the reader 52 can be used. The offset reader 86 or an antenna of the reader 52 is disposed on a handlebar covering 80 of the bicycle 12 shown in FIGS. 1 or 4. Additionally to FIG. 2, FIG. 3 further shows the rear light 94 and the hub dynamo 92.

FIG. 4 shows a side view of the front part of a bicycle 12 with the stem housing 44 and fastening means 72 for fastening to the steering shaft 64 of a bicycle 12 and a fork support 74 for supporting on a front wheel fork 96. Furthermore, a cable store 76 for receiving the securing cable 42 in a space-saving manner is disposed below a bicycle basket 78 on the upper side of the stem housing 44. The cable store 76 is configured as a cable drum and independently winds up the loose securing cable 42 so that it cannot enter into the spokes during cycling.

A typical scenario for use of the bicycle securing system is described hereinafter. A user who wishes to remove a loan bicycle 12 for use notifies his wish to borrow to the user communication terminal 14 via a controller 66 and registers the data of a payment card. Thereupon, he receives an authorisation card with an RFID user data carrier 84 (FIG. 3) via an output and supply device 82. At the same time, a data set comprising reference data is transmitted by means of a communication device 68 in the user communication terminal 14 and a bicycle-side user communication device 54 to the evaluation and control device 48 of the bicycle 12 to which the wish to rent is allocated. The user is notified via the controller 66 which bicycle stand 16 with a bicycle 12 has been allocated to him.

The user can now bring the authorisation card with the user data carrier 84 into the reading range of the reader 52 for the user data carrier, whereupon the evaluation and control device 48 releases the actuation device of the bolt lock after confirming that the data of the user data carrier agrees with the reference data transmitted by the user communication terminal 14. This is accomplished by actuating and coupling-in the coupling 30. The user can now remove the double bolt 26 from the lock receptacle by means of the hand lever 28 and remove the bicycle 12. After a delay time has elapsed, the coupling 30 is automatically coupled out by a timer 88 of the evaluation and control device 48.

It is assumed that the existing charge of the rechargeable battery 50 is used for the power supply of the evaluation and control device 48 and the other electrical components during the registration, identification and removal process. During cycling the rechargeable battery 50 is recharged and buffered via the hub dynamo 92 of the front wheel. In the dark, the lighting device comprising front light 56 and a rear light 94 connected via a cable 60 can be switched on by means of the photosensor 70 and the evaluation and control device 48.

If the user wishes to temporarily park and secure the bicycle 12, he can use the securing cable 42 for this purpose, by withdrawing this from the cable store 76 and looping it around a suitable stationary fastening means and then inserting the free end of the securing cable 42 into the cable lock 40. In order that the cable lock 40 can be locked, the user holds the user data carrier in front of the reader 52, whereupon the coupling 30 is actuated via the evaluation and control device 58 and the cable lock 40 can then be locked via the hand lever 40. Again after a time delay predefined by the timer 88 has elapsed after coupling in the coupling 30, this is automatically uncoupled so that no further actuation of the bolt lock or cable lock 40 via the hand lever 28 is possible since the hand lever 28 can only be turned freely. Alternatively however, it can be provided that the securing part 42 engages and locks independently on insertion into the cable lock 40.

In order to release the connected bicycle 12 again, the user data carrier 84 is again held in front of the reader 52, whereupon the coupling 30 is coupled in via the controller 48 and the cable lock 40 can be opened via the hand lever 28. After releasing from the stationary fastening means, the securing cable 42 is again wound up by the cable drum of the cable store.

On returning the bicycle 12, the user data carrier is again held in front of the reader 52, the bicycle 12 is pushed with the pin 22 into the pin receptacle 18 of the bicycle stand 16 and the bolt lock is closed via the actuating lever 28 so that the locking pins 34 and 36 enter into the bolt receptacle. After the reader 46 has simultaneously come in reading contact with the RFID data carrier 20 on the bicycle stand 16 in this position, its identification is detected by the evaluation and control device 48 and transmitted via its own communication device 54 and the communication device 68 of the user communication terminal 14 to the user communication terminal 14 and return process is registered there.

Alternatively on return, it can be provided that the bicycle is automatically locked after inserting the pin 22 into the pin receptacle 18 of the bicycle stand 16, whereby the locking pins 34 and 36 independently enter into the bolt receptacle after temporary compression by the pin receptacle 18 of the bicycle stand 16 due to spring force.

The user then returns his user card with the user data carrier 84 via the output and supply device 82 of the user communication terminal 14, whereupon the costs for the rental are deducted. In this case, either the user's account is debited or a difference from a prepayment is reimbursed.

REFERENCE LIST

| | |
|---|---|
| 10 | Bicycle station |
| 12 | Bicycle |
| 14 | User communication terminal |
| 16, 16′ | Bicycle stands |
| 18 | Pin and bolt receptacle |
| 20 | Passive RFID data carrier |
| 22 | Pin |
| 24 | Reading and control device |
| 26 | Double bolt |
| 28 | Hand lever |
| 30 | Coupling |
| 32 | Direction-changing transmission means |
| 34 | Locking pin |
| 36 | Locking pin |
| 38 | Drive rod |
| 40 | Cable lock |
| 42 | Securing cable |
| 44 | Stem housing |
| 46 | Reader |
| 44 | Evaluation and control device |
| 50 | Rechargeable battery |
| 52 | Reader |
| 54 | Communication device |
| 56 | Front light |
| 58 | Cable |
| 60 | Cable |
| 62 | Connecting line |
| 64 | Steering shaft |
| 66 | Controller |
| 68 | Communication device |
| 70 | Photosensor |
| 72 | Fastening means |
| 74 | Fork support |
| 76 | Cable store |
| 78 | Bicycle basket |
| 80 | Handlebar covering |
| 82 | Output and supply device |
| 84 | User data carrier |
| 86 | Offset reader |
| 88 | Timer |
| 90 | Memory |
| 92 | Hub dynamo |
| 94 | Rear light |
| 96 | Bicycle fork |

1. A bicycle securing system consisting of a bicycle station comprising a user communication terminal and at least one bicycle stand, as well as at least one bicycle, wherein the bicycle stand and the bicycle comprise retaining and docking means as well as registration and identification means, wherein the retaining and docking means are configured positively on the bicycle and the bicycle stand side and the registration and identification means comprise an active reading and control device on the bicycle side and a passive RFID data carrier on the bicycle stand side.

2. The bicycle securing system according to claim 1, wherein the retaining and docking means on the bicycle side comprises a pin provided with a bolt lock on the bicycle side and a pin and bolt receptacle on the bicycle stand side.

3. The bicycle securing system according to claim 1, wherein the bolt lock and the reading and control device are disposed in a common stem housing.

4. The bicycle securing system according to claim 3, wherein the pin is an integral component of the stem housing.

5. The bicycle securing system according to claim 3, wherein the stem housing is fastened to the steering shaft of the front fork of the bicycle.

6. The bicycle securing system according to claim 5, wherein the stem housing is supported by means of a fork support from the front fork of the bicycle.

7. The bicycle securing system according to claim 1, wherein the bicycle stands have lateral flanks which cover the front forks of the bicycle in the docked state.

8. The bicycle securing system according to claim 1, wherein the bolt lock consists of a double bolt which is disposed spreadably in opposite directions in the pin and an actuating device, wherein the actuating device comprises a hand lever, a coupling which can be actuated by the reading and control device as well as a drive rod and direction-changing transmission means.

9. The bicycle securing system according to claim 8, wherein a cable lock of a securing cable is further disposed in the stem housing and an actuating member of the cable lock is coupled to the drive rod of the actuating device of the bolt lock.

10. The bicycle securing system according to claim 1, wherein the reading and control device comprises a reader for the RFID data carrier of the bicycle stand, a reader for a user data carrier, an evaluation and control device and a rechargeable battery.

11. The bicycle securing system according to claim 10, wherein the reader for the user data carrier is disposed in the stem housing.

12. The bicycle securing system according to claim 10, wherein the reader for the user data carrier or a reading antenna of this reader is disposed in an offset manner in a handlebar covering of the bicycle.

13. The bicycle securing system according to claim 1, wherein the reading and control device comprises a communication device for data exchange with the user communication terminal.

14. The bicycle securing system according to claim 1, wherein the reading and control device is connected to a hub dynamo in the front wheel of the bicycle and the charging of the rechargeable battery is controlled by the evaluation and control device.

15. The bicycle securing system according to claim 1, wherein the reading and control device is connected to a lighting device of the bicycle and the lighting device is controlled by the evaluation and control device via a photosensor.

16. The bicycle securing system according to claim 16, wherein a cable store for the securing cable is disposed on the stem housing.

17. The bicycle securing system according to claim 16, wherein the cable store is configured as a cable drum.

18. The bicycle securing system according to claim 16, wherein the cable store for the securing cable is disposed between the stem housing and a bicycle basket fastened thereabove.

19. The bicycle securing system according to claim 15, wherein a front light of the lighting device is disposed in an inner recess of the pin.
